(19) United States
(12) Patent Application Publication
(10) Pub. No.: US 2005/0204467 A1
(43) Pub. Date: Sep. 22, 2005

(54) Method and apparatus for bathing body parts

(76) Inventors: Joseph Bean, Bedford, NH (US); Steven H. Schwartz, Bedford, NH (US); Joseph Geringer, Merrimack, NH (US); Kenneth David Hadrris JR., Hollis, NH (US)

Correspondence Address: HAYES, SOLOWAY P.C., 175 CANAL STREET, MANCHESTER, NH, 03101, US

(21) Appl. No.: 10/803,021

(22) Filed: Mar. 17, 2004

(51) Int. Cl. E03C 1/00; A47K 3/022; A61H 35/00

(52) U.S. Cl. 4/622

(57) ABSTRACT

A system, apparatus and method for heating water for relaxing sore muscles in isolated areas of the body. Briefly described, in architecture, the system includes a basin that has a plurality of basin openings. The basin openings include at least one inflow opening and at least one outflow opening. A flow tube, which is substantially exterior to the basin, connects the inflow and outflow openings. A heating element is located substantially within the flow tube.

### TECHNICAL FIELD

The present invention is generally related to a bathing apparatus and, more particularly, an apparatus for bathing body parts, such as feet.

### BACKGROUND OF THE INVENTION

Most people experience muscle soreness during their lives. Often times, the muscle soreness is exhibited in an isolated area. A common treatment for relieving muscle soreness is heat, such as that provided by a warm bath. Some muscle soreness, such as soreness in the hands, elbows, and feet, can be treated by bathing the muscles in a small basin of warm water.

Bathing has become a recognized therapeutic method for treating muscle soreness in the feet. For example, soaking soothes sore feet and aids in recovery from fatigue. Bathing of the feet also stimulates the circulation of blood in the feet, which results in increased metabolism and excretion. In addition, foot bathing facilitates the removal of painful growths, including calluses, bunions, and corns.

Many types of footbaths have been utilized as therapeutic devices for the feet. Typically, footbaths provide water, which is heated by some electronic means. Some footbaths use a heated element underneath the bottom of the footbath, which heats the base of the footbath and, there through, the water. Unfortunately, since most footbath basins are plastic, the heating elements cannot be heated to a very high temperature without risking melting the basin. As a result, the water in these types of footbaths is tepid, at best.

Another method of heating water in a footbath is to circulate water through a pipe exterior to the footbath basin and heat that pipe. Under this method of heating water, the pipe is made of a metal that is heated by an exterior heating element. As the pipe is normally located in close proximity to the footbath basin, the pipe cannot be heated to a significant temperature without risking melting the basin. As a result, the water in these types of footbaths is normally no more than tepid. Ideally, a footbath could be designed that could heat the water to a temperature warmer than tepid without risking damage to the footbath basin.

Thus, a heretofore unaddressed need exists in the industry to address the aforementioned deficiencies and inadequacies.

### SUMMARY OF THE INVENTION

Embodiments of the present invention provide a system, apparatus and method for heating water to temperatures heretofore unachieved for relaxing sore muscles in isolated areas of the body.

Briefly described, in architecture, a first embodiment of the system, among others, can be implemented as follows. A basin has a plurality of basin openings. The basin openings include at least one inflow opening and at least one outflow opening. A flow tube, which is substantially exterior to the basin, connects the inflow and outflow openings. A heating element is located substantially within the flow tube.

Briefly described, in architecture, a second embodiment of the system, among others, can be implemented as follows. A basin has a plurality of basin openings. The basin openings include at least one inflow opening and at least one outflow opening. A flow tube, which is substantially exterior to the basin, connects the inflow and outflow openings. A heating element is located substantially within the flow tube to heat the water. An impeller is located along the flow tube to cause the water to flow into the inflow opening, through the flow tube, and out the outflow opening, thereby circulating the heated water.

The present invention can also be viewed as providing methods for heating water in a basin, which has a plurality of openings and at least one flow tube substantially exterior to the basin connecting the openings, to relax muscles. In this regard, one embodiment of such a method, among others, can be broadly summarized by the following steps: pouring water into the basin, which at least partially fills a flow tube with water; heating a heating element in the flow tube, which heats the water in the flow tube and, therethrough, heats the water in the basin; and directing a flow of the heated water via at least one adjustable nozzle.

The present invention can also be viewed as providing a system for heating water to relax muscles. The system includes a means for storing water. The system also includes a means for circulating water. The system further includes a means for heating water to a temperature over about 100 degrees Fahrenheit.

Other systems, methods, features and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a top view of a first exemplary embodiment of the present invention.

FIG. 2 is a bottom view of the first embodiment of the present invention shown in FIG. 1.

FIG. 3 is a front side view of the first exemplary embodiment of the present invention shown in FIG. 1 and FIG. 2.

FIG. 4 is a top view of a second exemplary embodiment of the present invention.

FIG. 5 is a bottom view of the second exemplary embodiment of the present invention shown in FIG. 4.

FIG. 6 is a front side view of the second exemplary embodiment of the present invention shown in FIG. 4 and FIG. 5.

FIG. 7 is a flow diagram of the operation of the present invention according to the secondary embodiment.

### DETAILED DESCRIPTION

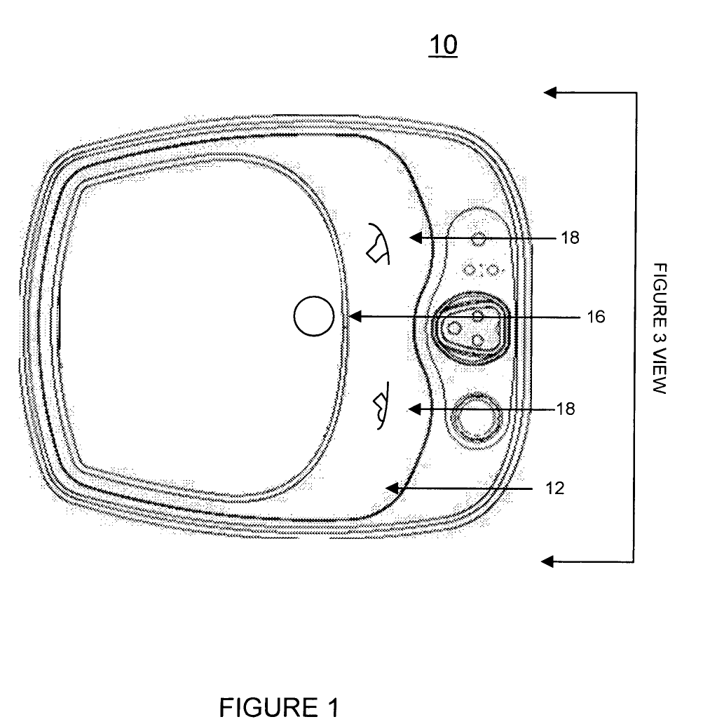

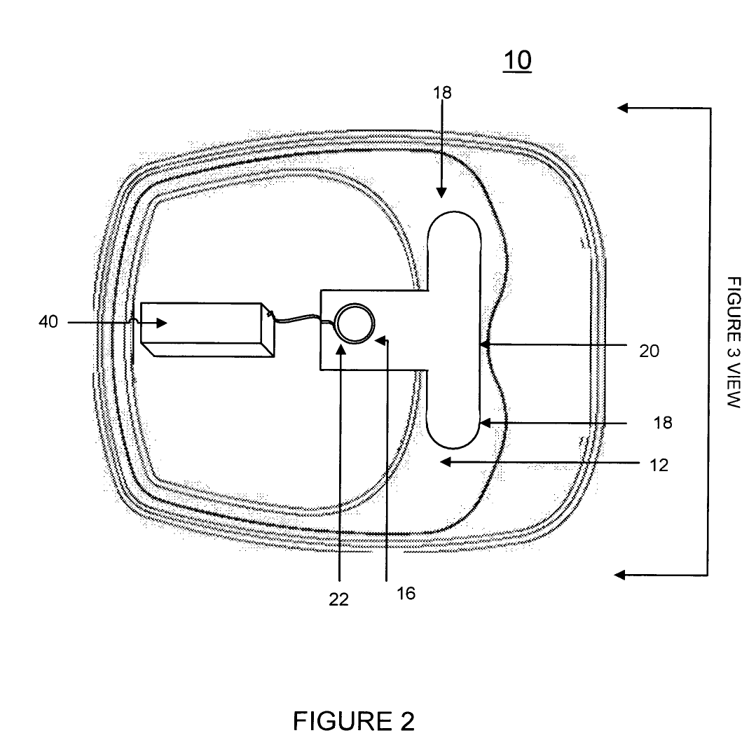

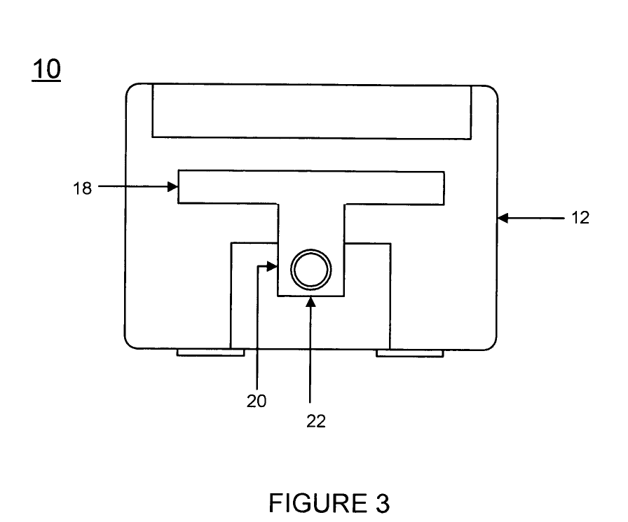

FIG. 1, FIG. 2, and FIG. 3 show a first exemplary embodiment of an apparatus 10 for bathing one or more body parts, such as, but not limited to, feet of a user. The following describes the apparatus 10 as a footbath. It should be noted, however, that the apparatus need not be limited to bathing feet.

FIG. 1 shows a top view of the first exemplary embodiment of the footbath 10. FIG. 2 shows a bottom view of the first exemplary embodiment wherein a bottom cover has been removed to expose inner portions of the footbath 10. FIG. 3 shows a side view of the first exemplary embodiment, again with the bottom cover removed. The footbath 10 includes a basin 12 that retains the water for bathing. The basin 12 includes a plurality of basin openings. The basin openings include at least one inflow opening 16 and at least one outflow opening 18. A flow tube 20, substantially exterior to and, in the first exemplary embodiment, beneath the basin 12, connects the inflow opening 16 to the outflow opening 18. A heating element 22 is located substantially within the flow tube 20.

The location of the heating element 22, shown in FIG. 2, serves a couple of purposes. The primary purpose of the heating element 22 is to heat the water. Placing the heating element 22 in direct contact with the water makes this design energy efficient. Placing the heating element 22 out of reach from any body parts to be bathed protects those body parts from potential burning. Also, by putting the heating element 22 inside the flow tube 20 the basin 12 is shielded from the heat of the heating element 22. If the basin 12 is made of plastic, the heating element 22 can reach higher temperatures than previously available in the prior art without melting the basin 12. Further, by having the heating element 22 submersed in water, a natural cooling agent, the flow tube 20 could be made of plastic without risk of melting from the heating element 22. The design of the footbath 10 can allow the water to be heated to over 100 degrees Fahrenheit by the heating element 22.

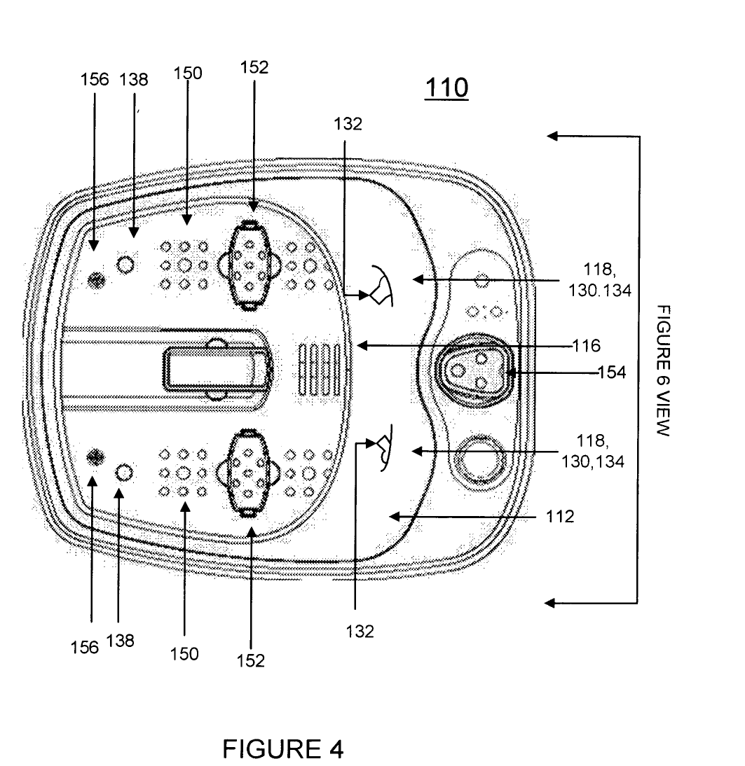

The basin 12 may be constructed in any of a number of different designs. The basin 12 may be constructed of a dense plastic or other durable, water impermeable material. The basin 12 may be partitioned, as is shown in a second exemplary embodiment in FIG. 4, or may be provided as a wide-open tub. The basin 12 may further be provided with a number of additional features as will be described in further detail herein. Many variations and modifications may be made to the design of the basin 12 without departing substantially from the spirit and principles of the invention. In accordance with the first exemplary embodiment of the invention, the basin 12 is shaped so as to allow feet of a user to rest therein.

A number of other variations on the first exemplary embodiment exist. As shown in FIG. 2 and FIG. 3, the outflow opening 18 is located on a bottom portion of the basin 12, while the inflow openings 16 are formed in a front side of the basin 12. The outflow opening 18 may be formed anywhere along the basin 12, as long as the outflow opening 18 is in position to be at least partially submerged when the basin 12 is filled with water. Similarly, the inflow openings 16 may be formed on any side or on the bottom of the basin 12, as long as the inflow openings 16 are in position to at least be partially submerged when the basin 12 is filled with water. Any number of inflow openings 16 and outflow openings 18 are possible, as long as they are connected to the flow tube 20.

The flow tube 20 also has many available design deviations. The flow tube 20 may run along the underside of the basin 12, as shown in FIG. 2, or may wrap around a side of the basin 12, depending, in part, on the placement of the openings 16,18. Also, depending on the number of openings 16,18, more than one flow tube 20 may be employed. The flow tube 20 may be made of metal, but is preferably made of plastic. The inside of the flow tube 20 should not come into contact with the heating element 22, but may be in close proximity with the heating element 22. Many variations and modifications may be made to the design of the flow tube 20 without departing substantially from the spirit and principles of the invention.

The heating element 22 may be operated in a variety of manners known to those skilled in the art. In the first exemplary embodiment, the heating element 22 is a resistive heater. A current is supplied from a power source 40, through the heating element 22, which causes the heating element 22 to heat and, thus, warm the water within the flow tube 20. The power source 40 may be battery powered, may receive power from a wall outlet, or both. More than one heating element 22 may be used, particularly if more than one flow tube 20 is used. The heating element 22 should be contained sufficiently within the flow tube 20 to avoid contact with bathing body parts. Toward this end, the openings 14 may contain screens or other obstructions that permit the flow of water into the flow tube 20 without permitting a body part to be inserted in the flow tube 20. Many variations and modifications may be made to the design of the heating element 22, including the use of means other than resistive heaters, without departing substantially from the spirit and principles of the invention.

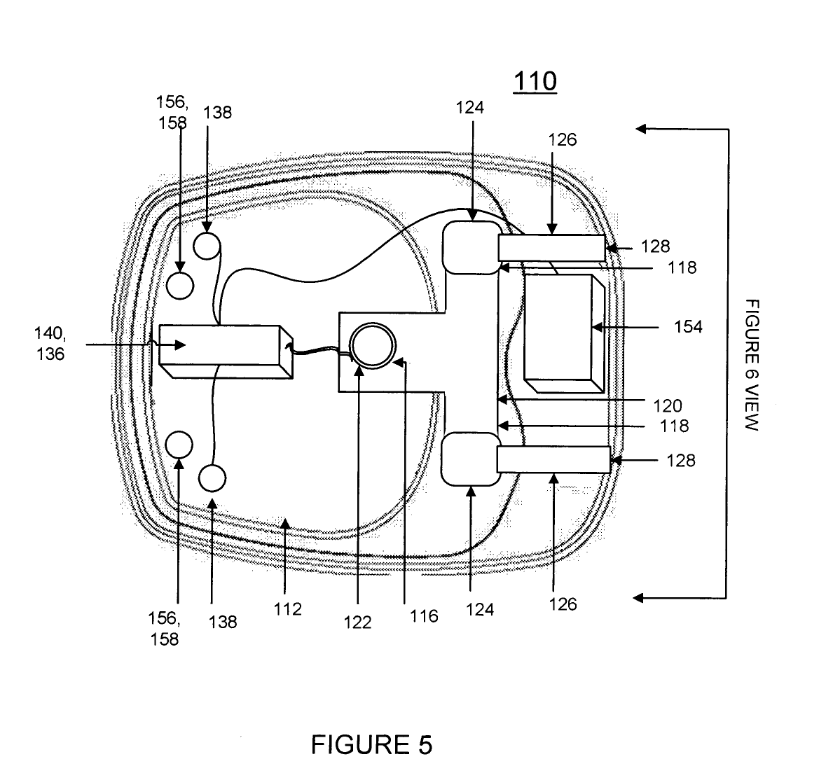

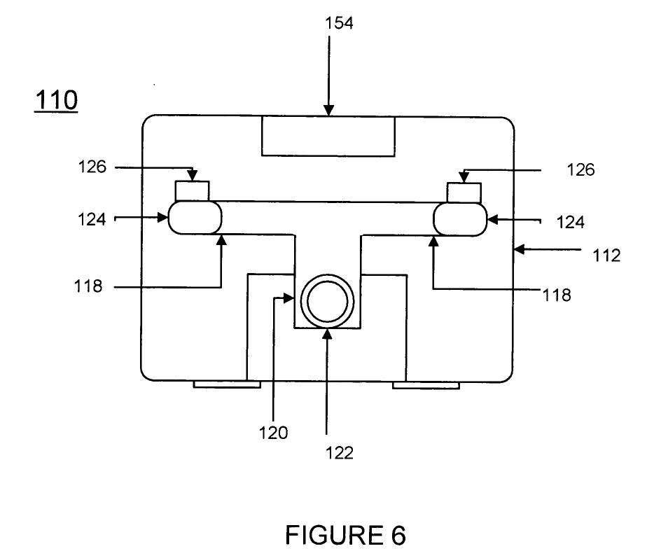

FIG. 4, FIG. 5 and FIG. 6 show a second exemplary embodiment of the footbath 110. FIG. 4 shows a top view of the second exemplary embodiment of the footbath 110. FIG. 5 shows a bottom view of the second exemplary embodiment wherein a bottom cover has been removed to expose the inner workings of the footbath 110.

FIG. 6 shows a front side view of the second exemplary embodiment, again with the bottom cover removed, as well as a side cover removed. The footbath 110 includes a basin 112 that retains water for bathing. The basin 112 includes a plurality of basin openings. The basin openings include at least one inflow opening 116 and at least one outflow opening 118. A flow tube 120, substantially exterior to and, in the second exemplary embodiment, beneath the basin 112, connects the inflow opening 116 to the outflow opening 118. A heating element 122 is located substantially within the flow tube 120. At least one impeller 124 is connected to the flow tube 120, impelling water from the outflow opening 118, through the flow tube 120, and out the inflow opening 116. The second exemplary embodiment circulates the warm water through the basin 112 more than the first exemplary embodiment.

The impeller 124 may be driven in many different ways known to those skilled in the art. The impeller 124 may be designed to include a centrifugal pump, wherein the impeller 124 is fixed on a rotating shaft and enclosed in a casing, having an inlet and outlet portion, such that the rotating impeller 124 creates pressure in the liquid, impelling the water to flow.

A different design would be to fix the impeller 124, enclosed in a casing, on a rotatable shaft and drive the impeller 124 rotationally with an electromagnet, such that the rotating impeller 124 creates pressure in the liquid, impelling the water to flow. In some designs, the speed of the impeller 124 may be made adjustable for the user. Many variations and modifications may be made to the operation and design of the impeller 124 without departing substantially from the spirit and principles of the invention.

The position of the impeller 124 may vary from the position shown in the second exemplary embodiment. The impeller 124 may be positioned within the flow tube 120 whereby the impeller 124 impels water through the flow tube 120. In another design variation, the impeller 124 could be positioned at one of the openings 114 to impel water through the flow tube 120. Also, the impeller 124 may be positioned tangential to the flow tube 120 to impel water through the flow tube 120. Many variations and modifications may be made to the operation and position of the impeller 124 without departing substantially from the spirit and principles of the impeller 124, which is to create a flow of water through the flow tube 120.

The footbath 110 may include additional elements. According to the second exemplary embodiment, and shown in FIG. 4, the basin 112 may contain protrusions 150, which help to massage the body parts resting in the warmed water. Arch rollers 152, may also be provided for massaging the arches of feet when feet of a user are soaked in the basin 112. The basin 112 may be bifurcated to allow for the positioning of two feet within the basin 112. Also, a control panel 154 may be provided for controlling the operation of the footbath 110. The control panel 154 may also be designed to receive signals from a remote control for controlling the operation of the footbath 110.

Also, at least one drain hole 156 may be provided to drain water from the basin 112 after use, wherein caps 158 are fixed to the drain holes 156 at the underside of the basin 112 to keep water from draining while the footbath 110 is in use. The footbath 110 may further include a tub (not shown) to be placed beneath the basin 112, to catch any water that leaks or spills from the basin 112. One alternative to the drain holes 156 would be to allow the user to simply turn the basin 112 on its side to release the water contained therein.

One of the designs for the present invention call for the water to be maintained at a temperature of approximately 108 degrees Fahrenheit. One way to maintain the temperature is to use a thermistor 136, electrically connected to the heating element 122 and to one or more temperature sensors 138. The thermistor 136 will cause the temperature of the heating element 122 to rise if the water temperature falls below a desired level and cause the temperature of the heating element 122 to lower if the water temperature rises above a desired level. If the heating element 122 is a resistive heating element, the thermistor 136 will vary the temperature of the heating element 122 by controlling an intensity of the electrical current passing through the heating element 122. As shown in FIG. 5, the thermistor 136 may be connected to or integral with the power source 140, which would otherwise control the current passing through the heating element 122. The water temperature level may be preset or the user may control it through the control panel 154.

As shown in the second exemplary embodiment in FIG. 6, the footbath 110 may include an air inlet 126 connected to the impeller 124 whereby the impeller 124 impels air and water through the flow tube 120. As is shown, an air inlet 126 is provided through an exterior portion of the basin 112 and piped to each of the impellers 124. Impelling air through the flow tube 120 and inflow openings 116 onto a body part being bathed further massages the body part being bathed. One alternative design would pipe air from a single air inlet 126, which was split to feed each of the impellers 124. The footbath 110 may be designed such that the air inlet opening 128 in the air inlet 126 is adjustable, thereby making adjustable the amount of air impelled through the flow tube 120 and out the inflow openings 116. Many variations and modifications may be made to the operation and design of the air inlet 126 without departing substantially from the spirit and principles of the invention.

Also shown in the second exemplary embodiment, particularly in FIG. 4, at least one position-adjustable nozzle 130 is located in at least one of the inflow openings 116, the nozzle 130 has a narrow nozzle opening 132 relative to the flow tube 120. Making the nozzle opening 132 narrower than a diameter of the flow tube 120 allows the nozzle 130 to provide a stronger, more focused jet of air and water than would otherwise be attained. As is shown in FIG. 4, at least one nozzle 130 may be joined to the basin 112 in at least one of the inflow openings 116 with a ball-and-socket joint 134. The ball-and-socket joint 134 allows the nozzle 130 a range of motion, such that the user of the footbath 110 may position the nozzle 130 to massage the feet of the user accordingly. In some designs, a direction of the nozzle 130 is adjusted electronically. Many variations and modifications may be made to the operation and design of the nozzle 130 and its connection to the basin 112 without departing substantially from the spirit and principles of the invention.

The second exemplary embodiment shows that a plurality of nozzles 130 and a plurality of impellers 124 may be provided. As shown in FIG. 6, each nozzle 130 is connected to a separate impeller 124, while the air inlets 126 feed each of the two impellers 124. This individualized assignment of nozzle 130 to impeller 124 creates a balanced flow of water from the nozzles 130. In alternative designs, multiple nozzles 130 may be fed by a single impeller 124, a single nozzle 130 may be fed by multiple impellers 124, or a plurality of nozzles 130 and impellers 124 may exist without any one-to-one correspondence between them. Many variations and modifications may be made to the operation and design of the nozzle 130 and impeller 124 relationship without departing substantially from the spirit and principles of the invention.

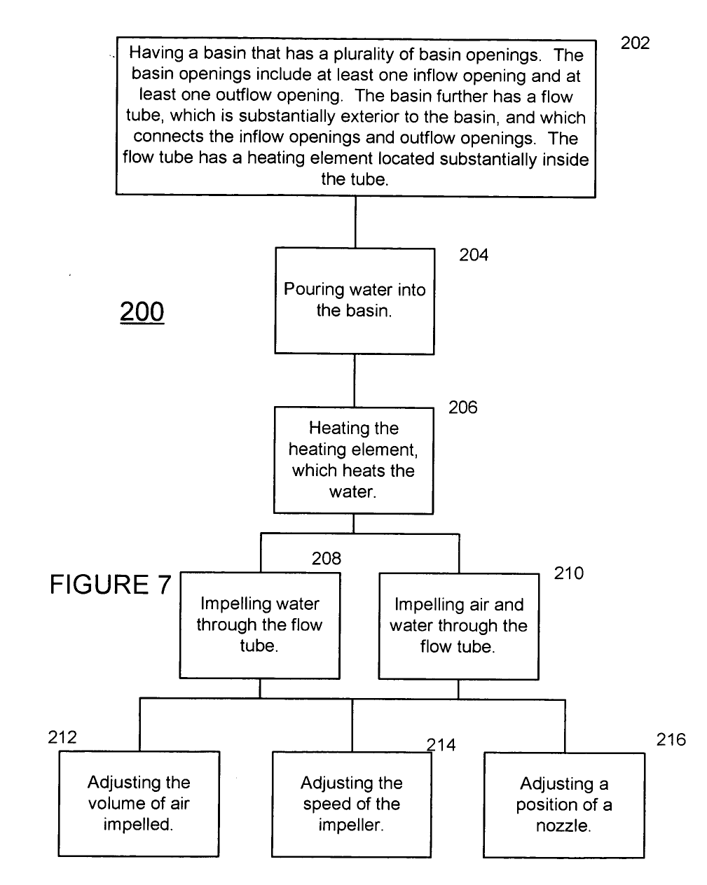

FIG. 7 is a flowchart illustrating the architecture, functionality, and operation of a possible implementation of the second exemplary embodiment of the footbath 110 of FIG. 4. In this regard, each block represents a module or segment, which comprises one or more executable instructions for implementing the specified function(s). It should also be noted that in some alternative implementations, the functions noted in the blocks may occur out of the order noted in the flow charts. For example, two blocks shown in succession may in fact be executed substantially concurrently or the blocks may sometimes be executed in the reverse order, depending upon the functionality involved, as will be further clarified hereinbelow.

Referring to FIG. 7, the present invention can be viewed as providing a method 200 for heating water in a basin 112. The method 200 shown in FIG. 7 utilizes the second exemplary embodiment of the footbath 110 (block 202), as described above. Water is poured into the basin 112 (block 204), which results in the flow tube 120 at least partially filling with water. Then the heating element 122 in the flow tube 120 is heated (block 206), which heats the water in the flow tube 120 and the water in the basin 112, which is in communication with the water in the flow tube 120.

Heating the heating element 122 (block 206) may involve heating the water to a temperature in excess of 100 degrees Fahrenheit. Heating the heating element 122 (block 206) may also involve heating the heating element 122 to a temperature in excess of 100 degrees Fahrenheit.

The method 200 may further be adapted to take advantage of other features of the second exemplary embodiment of the footbath 110. The method 200 further includes impelling water through the flow tube 120 with an impeller 124 (block 208). While not required, impelling water through the flow tube 120 allows the water in the basin 112 to reach a balanced, warm temperature more quickly. Air from an air inlet 26 may be impelled, along with the water, through the flow tube 120 with an impeller 124 (block 210). The method 200 may include adjusting the volume of air impelled (block 212) and adjusting a speed of the impeller 124 (block 214). Another adaptation of the method 200 includes adjusting a position of a nozzle 130 directing the flow of impelled air and water (block 216).

It should be emphasized that the above-described embodiments of the present invention are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

1. An apparatus for bathing a body part, said apparatus comprising:
a basin;
a plurality of basin openings formed in said basin, said basin openings including at least one inflow opening and at least one outflow opening;
a flow tube, substantially exterior to the basin, connecting the inflow opening to the outflow opening; and
a heating element located substantially within the flow tube.

2. The apparatus of claim 1, wherein the heating element maintains a volume of water within the basin at a temperature of at least about one hundred degrees Fahrenheit.

3. The apparatus of claim 1, further comprising an impeller positioned at least partially within the flow tube whereby the impeller impels water through the flow tube.

4. The apparatus of claim 1, further comprising an impeller positioned at one of the basin openings, whereby the impeller impels water through the flow tube.

5. The apparatus of claim 4, further comprising an air inlet connected to the impeller whereby the impeller impels air and water through the flow tube.

6. The apparatus of claim 5, wherein an air inlet opening in the air inlet is adjustable, thereby making adjustable the amount of air impelled through the flow tube.

7. The apparatus of claim 4, wherein a speed of the impeller is adjustable.

8. The apparatus of claim 1, further comprising at least one position-adjustable nozzle in at least one of the inflow openings, said nozzle having a narrow, nozzle opening relative to the flow tube.

9. The apparatus of claim 1, further comprising at least one nozzle joined to the basin in at least one of the inflow openings, wherein the nozzle is joined to the basin with a ball-and-socket joint, thereby allowing a direction of the nozzle to be adjusted.

10. The apparatus of claim 9 wherein the direction of the nozzle is adjusted electronically.

11. The apparatus of claim 1 further comprising a plurality of nozzles and a plurality of impellers, wherein each nozzle of the plurality of nozzles is connected to a separate impeller from the plurality of impellers.

12. The apparatus of claim 1, further comprising a volume of water in the basin and the flow tube, wherein a temperature of the volume of water is adjustable.

13. A method for heating water in a basin for bathing a body part, the basin including a plurality of basin openings formed in said basin, including at least one inflow opening and at least one outflow opening, and a flow tube, substantially exterior to the basin, connecting the inflow opening to the outflow opening, said method comprising the steps of:
pouring water into the basin, which at least partially fills the flow tube with water;
heating a heating element in the flow tube, which heats the water in the flow tube and the water in the basin that is in communication with the water in the flow tube; and
directing flow of the heated water via at least one adjustable nozzle.

14. The method of claim 13, wherein the step of heating the heating element further comprises heating the water to a temperature in excess of 100 degrees Fahrenheit.

15. The method of claim 13, wherein the step of heating the heating element further comprises heating the heating element to a temperature in excess of 100 degrees Fahrenheit.

16. The method of claim 13, further comprising the step of impelling water through the flow tube with an impeller.

17. The method of claim 13, further comprising the step of impelling air and water through the flow tube with an impeller.

18. The method of claim 17, further comprising the step of adjusting an amount of air impelled through the flow tube.

19. The method of claim 17, further comprising the step of adjusting a speed of the impeller.

20. The method of claim 17, further comprising the step of adjusting a position of a nozzle directing the flow of impelled air and water.

21. A system for heating water to relax muscles, the system comprising:
means for storing water for bathing a body part;
means for circulating water; and
means for heating water.

22. The system of claim 21 wherein the means for circulating, further comprises a means for circulating air and a means for circulating water.
